(19) United States
(12) Patent Application Publication
(10) Pub. No.: US 2008/0059626 A1
(43) Pub. Date: Mar. 6, 2008

(54) METHOD FOR DISPLAY OF BLADE VIDEO LOCATION AND STATUS INFORMATION

(75) Inventors: Keith M. Campbell, Cary, NC (US); Raymond T. Greggs, Raleigh, NC (US); James G. McLean, Fuquay-Varina, NC (US); Caroline M. Metry, Cary, NC (US)

Correspondence Address: CANTOR COLBURN LLP - IBM RESEARCH TRIANGLE PARK, 20 Church Street, 22nd Floor, Hartford, CT, 06103, US

(73) Assignee: International Business Machines Corporation, Armonk, NY (US)

(21) Appl. No.: 11/464,225

(22) Filed: Aug. 14, 2006

(51) Int. Cl. G06F 15/173

(52) U.S. Cl. 709/224

(57) ABSTRACT

A computer implemented method and computer program product for providing status information in a central server having a chassis for operating a plurality of blade servers installed therein, includes polling at least one of the central server and installed blades for status information; packaging the status information; transmitting each package of status information to the central server and respective installed blades; reading the packaged status information; and providing a display of the status information.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to resource management in a central server and particularly to provision of status information.

2. Description of the Related Art

When being directly connected to the Keyboard, Video and Mouse (KVM) and Media Tray of a central server, it can be ambiguous as to which blade slot is serving a user, and whether the particular blade has ownership of the KVM and the media tray. For example, the only KVM and media tray indicators that are visible to the user are lighted buttons on each of the individual blades within the central server. For the user who is not sitting directly in front of the central server, the lighted buttons are not a practical or convenient resource for identifying which blade is serving the user or has KVM ownership. It is important to have a practical and versatile way to know what blade the user is on after a blade with KVM and media tray ownership is removed from a chassis, since the KVM and media tray are randomly allocated to another blade.

Also, it is desirable to be aware of all or any alerts, warnings or errors that are happening in the central server as a whole. The current method of doing this is to actively check the Management Module (M). That is, there is no mechanism to display a status of the particular blade or the status of other blades within the chassis. Unfortunately, as in the case of the user not physically located at the central server, checking the Management Module is not possible.

What is needed is a solution that remotely provides vital blade information such as slot number, KVM and media tray ownership, power, and blade or system errors, and integrating such information into the video output of all blades would greatly enhance the usability of the central server.

### SUMMARY OF THE INVENTION

The shortcomings of the prior art are overcome and additional advantages are provided through the provision of a computer implemented method for providing status information in a central server including a chassis for operating a plurality of blade servers installed therein, the method including: polling at least one of the central server and installed blades for status information; packaging the status information; transmitting each package of status information to the central server and respective installed blades; reading the packaged status information; and providing a display of the status information.

Also disclosed is a computer program product stored on machine readable media and including instructions for providing status information of a central server including a chassis for operating a plurality of blade servers installed therein, the instructions including: polling at least one of the central server and installed blades for status information; packaging the status information; transmitting each package of status information to the central server and respective installed blades; reading the packaged status information; and providing a display of the status information.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer implemented method for providing status information in a central server including a chassis for operating a plurality of blade servers installed therein, the method including: polling with one of a management module and an installed blade at least one of the central server and installed blades for status information; wherein the status information includes a status for at least one of a keyboard, a video display, a mouse, a media tray and information regarding at least one of ownership, blade slot number, error conditions, power consumption and management information packaging the status information; transmitting each package of status information to the central server and respective installed blades over an RS-485 communications bus; receiving each package in a baseboard management controller of each installed blade; reading the packaged status information; and providing a display of the status information by one of providing a direct overlay on a video display by writing the status information to the video BIOS of the video display and invoking a software client for providing at least one of a graphical display and a command line display of the status information.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a prior art central server;

FIG. 2 depicts the central server with a remote console for display of status information;

FIG. 3 is an exemplary window providing status information; and

FIG. 4 is a flow chart depicting aspects of a process for providing status information.

The detailed description explains the preferred embodiments of the invention, together with advantages and features, by way of example with reference to the drawings.

### DETAILED DESCRIPTION OF THE INVENTION

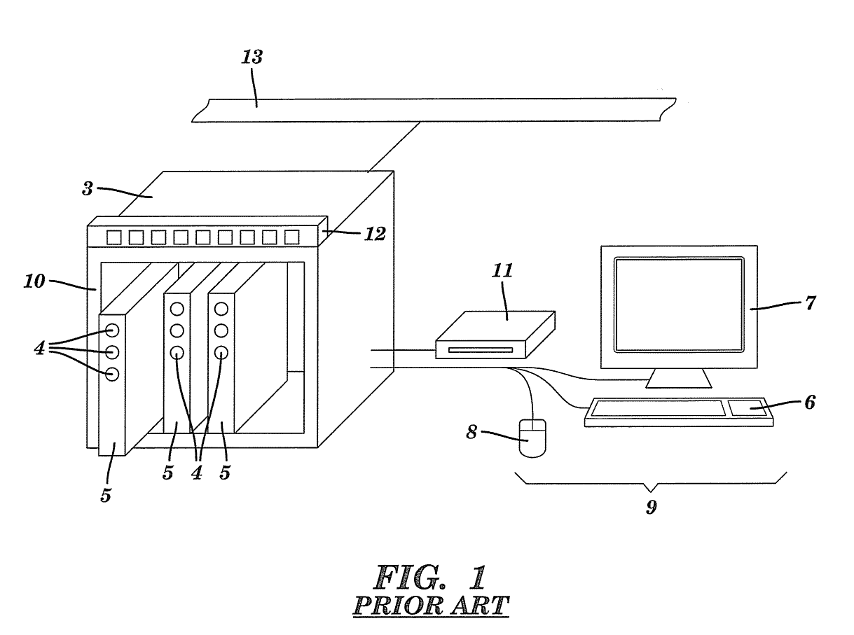

Referring to FIG. 1, there is shown an embodiment of a prior art central server 10 referred to as a BLADECENTER server. In one embodiment, the central server 10 includes a single chassis 3 into which a plurality of blades 5 (or blade server 5) fit in like books in a bookshelf. Typically, each of the blades 5 is an independent server, with its own processors, memory, storage, network controllers, operating system and applications (not shown). Each blade 5 slides into a bay in the chassis 3 and plugs into a mid-plane or backplane of the chassis. The plurality of blades are thus provided with shared power, fans, floppy drives, switches, ports and other supporting resources. In typical embodiments, each blade 5 is of a compact design, and “hot-swappable” (meaning designed for automatic installation and operation when inserted into the chassis 3 at power, and likewise removable at power).

Many critical components of the central server 10 can be made redundant or hot-swappable, including cooling systems, power supplies, Ethernet controllers and switches, mid-planes and backplanes, hard disk drives and service processors. In short, the central server 10 and the blades 5 therein provide resources for storing and executing software (machine readable instructions).

The benefits of using a central server 10 such as a BLADECENTER are known to anyone tasked with running down hundreds of cables strung through racks just to add and remove resources. With switches and power units shared, precious space is freed up. This means that blade servers 5 enable higher density of computing resources with far greater ease.

In blade technology, new servers are deployed by sliding blades 5 in and out of the chassis 3. Each blade 5 connects to infrastructure components coupled to the chassis 3. Therefore, most designs for blades 5 do not require plugging of multiple cables for installation. Exemplary infrastructure components include a keyboard 6, a video display 7, a mouse 8, a media tray 11 and a network 13. Collectively, the keyboard 6, video display 7 and mouse 8 are referred to as a KVM 9. Other components include a compact disc drive, a floppy drive, and other types of drives, which are collectively referred to as the “media tray 11.”

In typical embodiments, a plurality of lighted buttons 4 are included on each blade 5. The lighted buttons 4 provide, among other things, a status of the respective blade 5 regarding the operation of the KVM 9 and the media tray 11. For example, a given blade 5 may indicate ownership of at least one of the KVM 9 and the media tray 11 by having appropriate buttons 4 in a lighted condition. In one embodiment, a user may press the various buttons 4 of a blade 5 to assume control (ownership) over at least one of the KVM 9 and the media tray 11.

In advanced blade server systems, machine readable and executable instructions deployed as software provide additional aspects of functionality. For example, in one embodiment, when one slides the blade 5 into a bay of the chassis 3, the software automatically loads a designated operating system and application image into the blade 5. This provides for getting the newly installed blade 5 up and running with no human intervention. The software typically provides for repurposing of each blade 5 as necessary, replacing a failing blade 5 or applying spare blades 5 to help handle peak loads and may perform other functions as desired by system designers, managers or users.

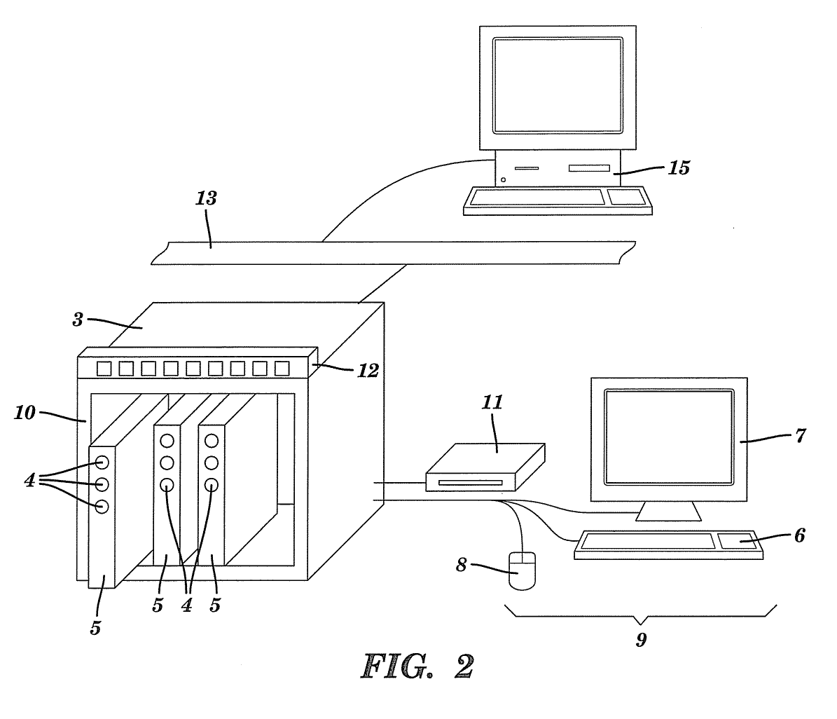

In one embodiment of the present invention, and with reference to FIG. 2, aspects of the chassis 3 are monitored and managed from a single location. For example, the chassis 3 can be managed from a console 15 used to manage other components in the computing infrastructure. In some embodiments, the central server 10 is managed through an easy-to-use graphical interface that allows remote connection from any terminal connected to the respective network 13. In typical embodiments, a management module 12 is included with the chassis 3. The management module 12 typically includes hardware as well as firmware for, among other things, communication with the various blades 5 and a network 13 connecting the central server 10 and other resources. Also typically, the console 15 includes an interface with the management module 12.

The teachings herein provide for improvements over the prior art by techniques that include communication of data between blades 5 and the management module 12. The data may include, without limitation, information regarding a slot location for each blade 5, a power status for each blade 5, ownership of the KVM 9 by a respective blade 5, ownership of the media tray 11 by a respective blade 5, an error status for a respective blade 5. The techniques also provide for integration of data gathered into a blade-specific graphical/textual format and display of that information by each individual blade 5.

As an example of the present teachings, when the user switches the video display 7 from a first blade 5 to a second blade 5, the video display 7 updates and displays information relevant to the second blade 5 (currently providing a video signal) and the system (i.e., the central server 10) as a whole.

Collecting and displaying status information. In typical embodiments, the management module 12 will gather status information for the central server 10 and each blade 5 and relay the information to the plurality of blades 5. The status information will include and is not limited to information regarding “blade slot number”, “Have errors been logged for this blade” “have errors been logged for other blades”, “does blade currently have (KVM)”, “Server power consumption and management information,” and other aspects of interest. In typical embodiments of the central server 10 (i.e., the BLADECENTER), the information relay will occur over a communications bus. One non-limiting example of the communications bus is an RS-485 bus, using H8 or IPMI protocols.

Given the great variety of resources that may be employed in a central server 10, it is considered likely that status information relevant to one blade 5 may not be relevant to another blade 5. The teachings herein provide for collection and display of status information that is common to each of the blades 5 as well as other status information that is unique to the various blades 5 and other components of the central server 10.

Once the status information is received by the Baseboard Management Controller (BMC) for each blade 5, the status information may be viewed by users logged onto the respective blade. Displaying the status information may be achieved by a variety of techniques, with the following methods being exemplary.

In a first technique, the status information contained in the BMC of the blade 5 is provided as a direct overlay on the video display 7 associated with the blade 5. One way to accomplish this is through video BIOS writes of the status information. APIs must be provided for the BMC to deliver graphical content to portions of the video BIOS.

In another technique, a software client which executes through the operating system of the blade 5 may display the status information. This software client may include a graphical display or a command line interface (useful for blades 5 which do not have video capabilities). The transactions between the BMC and the operating system will typically occur over the Low Pin Count (LPC) bus.

Both techniques serve to benefit users whether they are using the blades locally through the KVM 9 for the central server 10, or over a remote console 15 where the Blade video, keyboard, and mouse are packetized and sent over the network 13 to a client application.

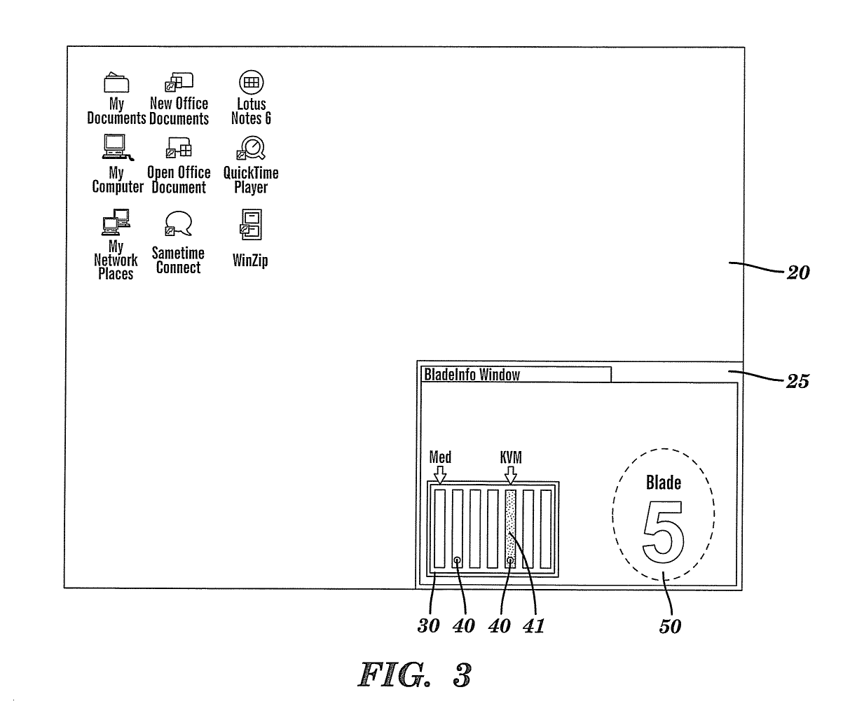

FIG. 3 depicts one possible graphical representation of the status information. In FIG. 3, a desktop 20 of a graphical interface is illustrated. The desktop 20 provides a window 25 that includes the status information. In this example, the status information is provided in a graphic representation that is based upon the architecture of the central server 10. That is, a server depiction 30, for this example includes the chassis 3 is illustrated as a box having seven blades therein. Light depictions 40 are provided to mimic the lighted buttons on the central server 10. Typically, the light depictions provide the same status information as would be available through viewing of the central server 10. A KVM indication 41 is provided, and shows which blade 5 of the plurality of blades 5 has ownership of the KVM 9. The KVM indication 41 (or other status information, for that matter) may also be displayed in a summary area 50 of the window 25. Techniques for calling, minimizing, maximizing the window 25 and general navigation therein may be applied. As these are known in the art, these techniques are not discussed further herein. Typically, the window 25 is capable of dynamic updates and supports hot-swapping of components in the central server 10.

In the window 25, a variety of conventions are used for display of the assortment of status information that is gathered. As techniques for display of such status information are generally well known, these are also not discussed in greater depth herein.

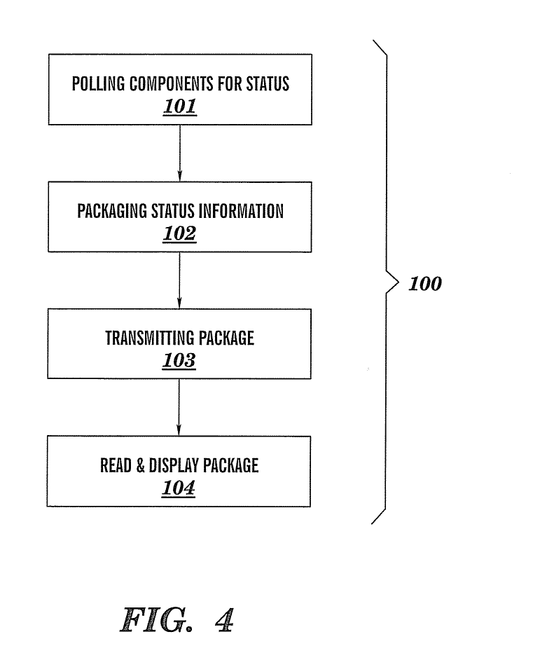

FIG. 4 provides an exemplary process for providing status information 100. In this example, providing status information 100 calls for polling 101, packaging 102, transmitting 103 and displaying 104 the status information. Typically, polling 101 is completed at a frequency that provides users with meaningful status information, while not creating a traffic burden the to central server 10. Once the status information is collected from the central server 10 (including, at least in some embodiments, the management module) and any of the installed blades 5, the status information is packaged. Typically, packaging involves packaging the information using any known technique for consolidating data and creating a data file. Each package may include some or all of the status information. Once the status information is packaged, the package of status information is transmitted. Transmitting 103 typically uses whatever communications protocol is desired for data communications within the central server 10. Typically, displaying 104 employs a client software application to read each package of status information and provide the display thereof.

Providing status information 100 is typically completed by the management module 12, however, providing 100 may be completed by any resource as desired. For example, providing 100 may be assigned to the blade 5 having KVM ownership, or a certain default blade order.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer implemented method for providing status information in a central server comprising a chassis for operating a plurality of blade servers installed therein, the method comprising:
polling at least one of the central server and installed blades for status information;
packaging the status information;
transmitting each package of status information to the central server and respective installed blades;
reading the packaged status information; and
providing a display of the status information.

2. The computer implemented method of claim 1, wherein the polling comprises polling by one of a management module and an installed blade.

3. The computer implemented method of claim 1, wherein the status information comprises a status for at least one of a keyboard, a video display, a mouse and a media tray.

4. The computer implemented method of claim 1, wherein the status information comprises information regarding at least one of: ownership, blade slot number, error conditions, power consumption and management information.

5. The computer implemented method of claim 1, wherein transmitting comprises transmitting the packaged status information over a communications bus.

6. The computer implemented method of claim 1, wherein the communications bus comprises an RS-485 bus.

7. The computer implemented method of claim 1, further comprising receiving each package in a baseboard management controller of each installed blade.

8. The computer implemented method of claim 1, wherein displaying comprises providing a direct overlay on a video display.

9. The computer implemented method of claim 8, further comprising writing the status information to the video BIOS of the video display.

10. The computer implemented method of claim 1, wherein displaying comprises invoking a software client for providing at least one of a graphical display and a command line display of the status information.

11. A computer program product stored on machine readable media and comprising instructions for providing status information of a central server comprising a chassis for operating a plurality of blade servers installed therein, the instructions comprising:
polling at least one of the central server and installed blades for status information;
packaging the status information;
transmitting each package of status information to the central server and respective installed blades;
reading the packaged status information; and
providing a display of the status information.

12. The computer program product of claim 11, wherein the polling comprises polling by one of a management module and an installed blade.

13. The computer program product of claim 11, comprises a status for at least one of a keyboard, a video display, a mouse and a media tray.

14. The computer program product of claim 11, wherein the status information comprises information regarding at least one of: ownership, blade slot number, error conditions, power consumption and management information.

15. The computer program product of claim 11, wherein transmitting comprises transmitting the packaged status information over a communications bus.

16. The computer program product of claim 11, wherein displaying comprises providing a direct overlay on a video display.

17. The computer program product of claim 11, further comprising writing the status information to the video BIOS of the video display.

18. The computer program product of claim 11, wherein displaying comprises invoking a software client for providing at least one of a graphical display and a command line display of the status information.

19. A computer implemented method for providing status information in a central server comprising a chassis for operating a plurality of blade servers installed therein, the method comprising:
polling with one of a management module and an installed blade at least one of the central server and installed blades for status information;
wherein the status information comprises a status for at least one of a keyboard, a video display, a mouse, a media tray and information regarding at least one of ownership, blade slot number, error conditions, power consumption and management information
packaging the status information;
transmitting each package of status information to the central server and respective installed blades over an RS-485 communications bus;
receiving each package in a baseboard management controller of each installed blade;
reading the packaged status information; and
providing a display of the status information by one of providing a direct overlay on a video display by writing the status information to the video BIOS of the video display and invoking a software client for providing at least one of a graphical display and a command line display of the status information.
